(19) United States
(12) Patent Application Publication
(10) Pub. No.: US 2024/0339672 A1
(43) Pub. Date: Oct. 10, 2024

(54) Multi-Energy Battery System and Method of Use

(71) Applicant: Brandi Reed, Henderson, NV (US)

(72) Inventor: Brandi Reed, Henderson, NV (US)

(21) Appl. No.: 18/627,552

(22) Filed: Apr. 5, 2024

Related U.S. Application Data
(60) Provisional application No. 63/458,235, filed on Apr. 10, 2023.

(51) Int. Cl. H01M 10/36; H01M 10/46; H02J 7/00

(52) U.S. Cl. CPC H01M 10/36; H01M 10/465; H02J 7/00302; H02J 7/00309; H01M 2300/0002

(57) ABSTRACT

A multi-energy battery system that can be powered by multiple sources is disclosed. The system includes at least one cathode and at least one anode, separated by a selective membrane that prevents short circuits and controls ionic flow. The system is encased in a sealed housing and uses saltwater as an electrolyte, enabling efficient ion movement and electricity production. The system includes multiple energy connection ports for interfacing solar panels and external devices. An integrated control module manages charging, preventing overcharging and overheating. The battery system can be scaled with multiple cathodes and anodes to meet diverse power needs and includes a rechargeable battery for storing additional electric power.

### CROSS-REFERENCE TO RELATED APPLICATION

The present application claims priority to, and the benefit of, U.S. Provisional Application No. 63/458,235, which was filed on Apr. 10, 2023 and is incorporated herein by reference in its entirety.

### FIELD OF THE INVENTION

The present invention generally relates to the field of battery systems. More specifically, the present invention relates to a novel multi-energy battery system that provides a more reliable and sustainable source of energy. The system uses saltwater as an electrolyte, at least one solar panel, and electrodes along with a membrane to provide an energy source. The battery system can be used for different applications including but not limited to portable electronic devices, electric vehicles, remote or off-grid applications, grid-scale storage, and more. Accordingly, the present disclosure makes specific reference thereto. Nonetheless, it is to be appreciated that aspects of the present invention are also equally applicable to other like applications, devices, and methods of manufacture.

### BACKGROUND

By way of background, batteries are the most common form of sustainable and reliable energy sources. Batteries are integral to a wide array of applications, from powering small-scale electronic devices to serving as energy storage systems for renewable power grids. Batteries range from portable devices to large, stationary installations, and from single-use chemistries to rechargeable systems.

Batteries, in their traditional form, harness chemical reactions to convert stored energy into electrical power. Different sources of energy are used, encompassing both renewable and non-renewable materials. Renewable sources, such as solar or wind, are increasingly popular in rechargeable battery systems. Non-renewable sources, including certain metals and chemicals, remain prevalent due to their high energy density and established technology base.

Existing batteries typically rely on a single source or method of energy generation. The dependency on single source restricts the flexibility and potential of batteries to adapt to varying energy availability and environmental conditions. For instance, a battery designed to recharge from solar energy alone would be less effective in geographical areas with limited sunlight. There is a desire for a multi-energy battery device that solves the traditional constraints of battery technology.

Therefore, there exists a long felt need in the art for a novel multi-energy battery device. There is also a long felt need in the art for a novel multi-energy battery device that can integrate multiple energy sources within a single battery system. Additionally, there is a long felt need in the art for a novel multi-energy battery device that provides a more sustainable energy source and can be powered by multiple sources of renewable energy. Moreover, there is a long felt need in the art for an improved multi-energy battery device that reduces dependence on non-renewable materials for battery operation. Further, there is a long felt need in the art for a multi-energy battery device that provides a more consistent and reliable power supply. Furthermore, there is a long felt need in the art for an improved battery design that uses water, solar, and salt to provide a battery that serves as an energy source. Finally, there is a long felt need in the art for an improved battery system that addresses both the limitations of current battery technologies and the broader challenge of sustainable energy storage.

The subject matter disclosed and claimed herein, in one embodiment thereof, comprises a multi-energy battery device. The battery system features one or more cathode and one or more anode, a membrane disposed along the cathode and the anode to enable for selective and controlled ionic flow between the anode and the cathode, a housing forming a sealed enclosure for the cathode and anode, the electrolyte used within the battery system comprises saltwater having Na+ and Cl-ions, and a plurality of energy connection ports located on a surface of the battery system, including a set of input ports configured to couple to at least one solar panel for receiving electric power generated by the solar panel and storing it within the battery system. The electric power from the solar panel can be used for generation of electrons from the anode and can also be stored in a rechargeable battery component of the device.

In this manner, the multi-energy battery device of the present invention accomplishes all of the forgoing objectives and provides users with a battery system that uses water, solar, and salt to provide a battery that serves as an energy source. The battery system can store energy using the solar power and electrochemical reaction, thereby providing multiple sources of energy. The battery system provides a sustainable source of energy which is not dependent on a single source of energy.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a multi-energy battery system. The battery system further comprises at least one cathode and at least one anode, a membrane disposed along the cathode and the anode to prevent direct contact between the cathode and the anode and to enable for controlled ionic flow, a housing forming a sealed enclosure for the battery system, wherein the electrolyte used within the battery system comprises saltwater (NaCl), and a plurality of energy connection ports located on a surface of the battery system, including a set of input ports configured to couple to at least one solar panel for receiving electric power generated by the solar panel and storing it within the battery system.

In yet another embodiment, the battery system includes an integrated control module adapted to manage charging of the battery system and to prevent overcharging and overheating, wherein the control module also controls the generation of electrons from the anode through the saltwater electrolyte without storing any charge in the electrolyte.

In another aspect, a multi-energy battery system is disclosed. The system further comprises a plurality of cathodes and a corresponding plurality of anodes, a selective membrane designed to enable only specific types of ions to pass, thereby preventing short circuits and enabling controlled ionic flow between the cathodes and anodes, a saltwater electrolyte facilitating the conductive movement of ions within the battery system, a plurality of energy connection ports capable of functioning as both input ports for connecting to solar panels and output ports for providing electric power to external devices, and a separate rechargeable battery within the battery system for storing excess electrical power generated by the solar panels when the main battery system does not require charging.

In yet another embodiment, a method of operating an environmentally friendly battery system is disclosed. The method comprises the steps of coupling at least one solar panel to a set of input ports on the battery system for receiving electric power generated by the solar panel, using the electric power to generate electrons from an anode which reach a cathode, changing the chemical composition of the electrodes and storing energy in the form of chemical energy within the battery system, utilizing a membrane disposed along the cathode and anode to control the ionic flow necessary for the battery's operation and to prevent direct contact between the cathode and anode, determining the charging level of the battery system with an integrated control module, and automatically redirecting electric power from the solar panel to recharge a separate rechargeable battery within the battery system when the main battery system is fully charged or does not require recharging.

The multi-energy battery system can be designed to use with portable electronic devices, electric vehicles, remote or off-grid applications, grid-scale storage, and more. The battery system can provide power from about 2 W to about 50 W to accommodate different requirements of users.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of the environmentally friendly battery system of the present invention in accordance with the disclosed structure;

FIG. 2 illustrates a functional block diagram showing the use of a charge control module for preventing overcharging or overheating of the battery device of FIG. 1 in accordance with the disclosed structure;

FIG. 3 illustrates another embodiment of the multi-energy battery device of the present invention in accordance with the disclosed structure; and

FIG. 4 illustrates a flow chart depicting a process of operation of the multi-energy battery device of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a novel multi-energy battery device. There is also a long felt need in the art for a novel multi-energy battery device that can integrate multiple energy sources within a single battery system. Additionally, there is a long felt need in the art for a novel multi-energy battery device that provides a more sustainable energy source and can be powered by multiple sources of renewable energy. Moreover, there is a long felt need in the art for an improved multi-energy battery device that reduces dependence on non-renewable materials for battery operation. Further, there is a long felt need in the art for a multi-energy battery device that provides a more consistent and reliable power supply. Furthermore, there is a long felt need in the art for an improved battery design that uses water, solar, and salt to provide a battery that serves as an energy source. Finally, there is a long felt need in the art for an improved battery system that addresses both the limitations of current battery technologies and the broader challenge of sustainable energy storage.

The present invention, in one exemplary embodiment, is a multi-energy battery system. The system further comprises a cathode and an anode, a selective membrane designed to enable only specific types of ions to pass between the cathode and the anode, a saltwater electrolyte for the conductive movement of ions within the battery system, a plurality of energy connection ports capable of functioning as both input ports for connecting to solar panels and output ports for providing electric power to external devices.

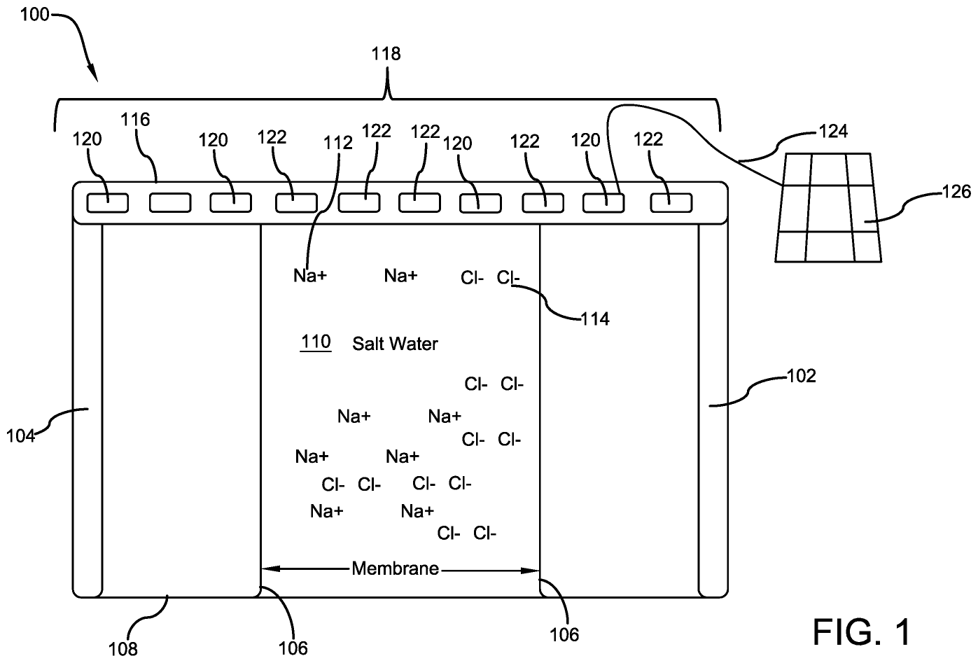

Referring initially to the drawings, FIG. 1 illustrates a perspective view of the environmentally friendly battery system of the present invention in accordance with the disclosed structure. The environmentally friendly battery system 100 of the present invention is designed as an improved battery system 100 that combines solar energy harvesting with an electrochemical cell that uses saltwater as an electrolyte. The battery system 100 reduces dependence on traditional battery chemistries that use more toxic materials.

More specifically, the hybrid battery system 100 includes at least one cathode 102 and at least one anode 104. A membrane 106 is disposed along the cathode 102 and the anode 104 to prevent the cathode 102 and the anode 104 from coming into direct contact with each other and causing short circuit in the battery device 100. The membrane 106 helps in controlled ionic flow which is necessary for the battery's operation. The membrane 106 is designed to be selective enabling only certain types of ions to pass, such as positive ions towards the anode of the battery system 100.

The choice of materials for the cathode 102 and the anode 104 can depend on the battery's voltage, capacity, and number of cathodes and anodes included in the housing 108 of the battery device 100. The housing 108 forms a sealed enclosure for the battery device 100 and prevents any power leakage therefrom. The electrolyte 110 used in the battery system 100 is in the form of saltwater (NaCl). The electrolyte 110 has salt (NaCl) dissolved in water, and when salt (NaCl) is dissolved in water, the salt separates into positive sodium ions (Na+) 112 and negative chloride ions (Cl−) 114. The ions freely move in the water, making the electrolyte 110 conductive. Specifically, Na+ ions 114 move towards the anode 104, and Cl− ions 114 move towards the cathode 102 to produce electricity.

The top end/surface 116 of the battery device 100 includes a plurality of energy connection ports 118 which includes a set of the input ports 120 for providing energy to store in the battery device 100. A set of output ports 122 are configured for providing electric power to different devices coupled to the battery device 100. The input ports 120 are configured to couple to at least one solar panel 126 for receiving electric power generated by the solar panel 126 and storing in the battery device 100. The solar panel 126 can be detachably coupled using a medium 124 to the input ports 120. The solar panel 126 includes a plurality of photovoltaic cells for converting the absorbed solar energy into electric power. The solar panel 126 can be designed based on the power storage capacity of the battery device 100. In some embodiments, ports 118 can function as input ports when solar panels are connected and can function as output ports when the solar panels are not connected and the battery device 100 is connected to external electrical appliances or grids.

The electricity generated by the solar panels 126 is used for generating electrons from the anode 104 which reach the cathode 102, thereby changing the chemical composition of the electrodes 102, 104. The energy is stored in the form of chemical energy which can be used for converting back into electrical energy for providing power through the output ports 122.

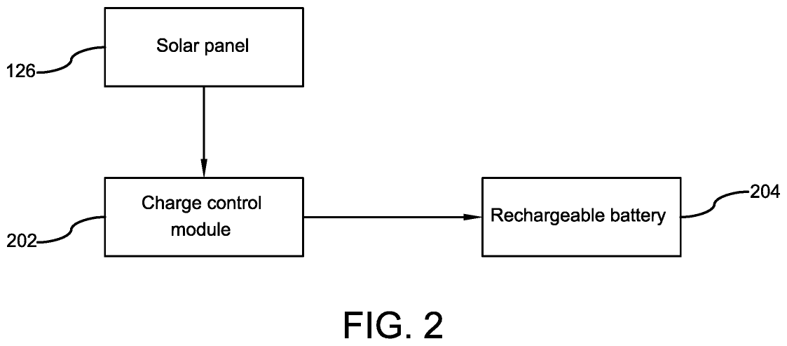

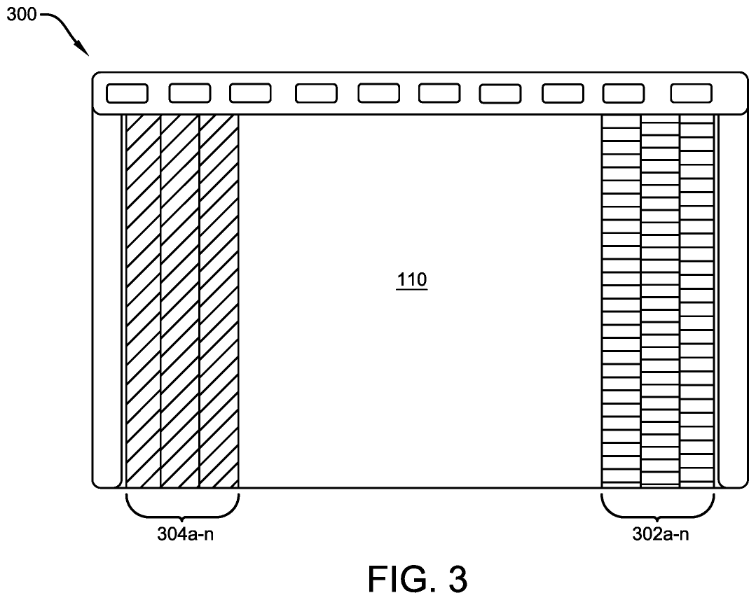

FIG. 2 illustrates a functional block diagram showing the use of a charge control module for preventing overcharging or overheating of the battery device of FIG. 1 in accordance with the disclosed structure. The multi-energy battery device 100 includes an integrated control module 202 which is adapted to cut off charging of the device 100 to prevent overcharging and overheating thereof. The control module 202 is adapted to manage the charging of the device 100 and controls generation of electrons from the anode 104 through the saltwater electrolyte without storing any charge in the electrolyte 110. The battery device 100 can be scaled to include a plurality of cathodes and anodes as illustrated in FIG. 3.

A separate and independent rechargeable battery 204 is included in the battery device 100 for automatic recharging using the electrical power generated by the solar panels 126. The battery 204 is recharged when the redox reaction (loss of electrons by anode 104 and absorption of electrons by cathode 102) is not required in the battery device 100. The switching to recharge the rechargeable battery 204 is automatically performed by the charge control module 202.

FIG. 3 illustrates another embodiment of the multi-energy battery device of the present invention in accordance with the disclosed structure. In the present embodiment, the battery device 300 includes a plurality of anodes 302a-n and a plurality of corresponding cathodes 304a-n for providing electric power. The number of anodes and cathodes can be scaled up and down according to the requirements of the users.

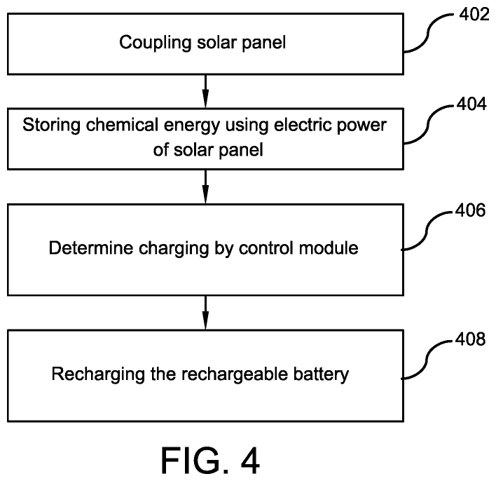

FIG. 4 illustrates a flow chart depicting a process of operation of the multi-energy battery device of the present invention in accordance with the disclosed structure. Initially, a solar panel is coupled to the battery device 100 for providing electric power (Step 402). The solar panel can be of any geometric shape and can be integrated or detachably attached to the battery device 100. Then, the chemical energy is stored in the battery device 100 using the redox reaction via the electric power of the solar panel (Step 404). Thereafter, the charging level of the battery device 100 is determined by the control module (Step 406) and if the battery level is recharged, then electric power of the solar panel is stored in the rechargeable battery (Step 408).

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “environmentally friendly battery system”, “improved battery system”, “multi-energy battery device” and “battery system” are interchangeable and refer to the multi-energy battery device 100, 300 of the present invention.

Notwithstanding the forgoing, the multi-energy battery device 100, 300 of the present invention can be of any suitable size and configuration as is known in the art without affecting the overall concept of the invention, provided that it accomplishes the above stated objectives. One of ordinary skill in the art will appreciate that the multi-energy battery device 100, 300 as shown in the FIGS. are for illustrative purposes only, and that many other sizes and shapes of the multi-energy battery device 100, 300 are well within the scope of the present disclosure. Although the dimensions of the multi-energy battery device 100, 300 are important design parameters for user convenience, the multi-energy battery device 100, 300 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A rechargeable battery system comprising:
a housing;
a cathode;
an anode;
an electrolyte;
a membrane;
a solar panel; and
a plurality of energy connection ports;
wherein said housing forming a sealed enclosure around said cathode, said anode, and said membrane;
wherein said plurality of energy connection ports having a set of input ports and a set of output ports;
wherein said set of output ports provide electric power source to a set of external devices; and
further wherein said set of input ports coupled to said solar panel for receiving electric power generated by said solar panel.

2. The rechargeable battery system of claim 1, wherein said solar panel selectively detachable from said set of input ports.

3. The rechargeable battery system of claim 2, wherein said solar panel having a plurality of photovoltaic cells for converting absorbed solar energy into electric power.

4. The rechargeable battery system of claim 3, wherein said set of input ports function as another set of output ports when said solar panel is detached from said housing.

5. The rechargeable battery system of claim 4, wherein said membrane positioned between said cathode and said anode for controlling ionic flow.

6. The rechargeable battery system of claim 5, wherein said membrane separates said cathode and said anode.

7. The rechargeable battery system of claim 6, wherein said electrolyte is saltwater.

8. The rechargeable battery system of claim 7, wherein said saltwater having positive sodium ions and negative chloride ions.

9. The rechargeable battery system of claim 8, wherein said positive sodium ions and said negative chloride ions move freely within said membrane and make said electrolyte conductive.

10. The rechargeable battery system of claim 9, wherein said positive sodium ions move towards said anode and said negative chloride ions move towards said cathode.

11. A rechargeable battery system comprising:
a housing;
a cathode;
an anode;
an electrolyte;
a membrane;
a solar panel;
a plurality of energy connection ports; and
a charge control module;
wherein said housing forming a sealed enclosure around said cathode, said anode, and said membrane;
wherein said plurality of energy connection ports having a set of input ports and a set of output ports;
wherein said set of output ports provide electric power to a set of external devices;
wherein said set of input ports coupled to said solar panel for receiving electric power generated by said solar panel;
wherein said charge control module adapted to cut off charging of the rechargeable battery system to prevent overcharging; and
further wherein said charge control module controls generation of electrons from said anode through said electrolyte without storing any charge is said electrolyte.

12. The rechargeable battery system of claim 11, wherein said solar panel selectively detachable from said set of input ports.

13. The rechargeable battery system of claim 11, wherein said solar panel having a plurality of photovoltaic cells for converting absorbed solar energy into electric power.

14. The rechargeable battery system of claim 11, wherein said set of input ports function as another set of output ports when said solar panel is detached from said housing.

15. The rechargeable battery system of claim 11, wherein said membrane positioned between said cathode and said anode for controlling ionic flow.

16. The rechargeable battery system of claim 11, wherein said membrane separates said cathode and said anode.

17. The rechargeable battery system of claim 11, wherein said electrolyte is saltwater.

18. The rechargeable battery system of claim 17, wherein said saltwater having positive sodium ions and negative chloride ions.

19. The rechargeable battery system of claim 18, wherein said positive sodium ions move towards said anode and said negative chloride ions move towards said cathode.

20. A method of operation of a multi-energy rechargeable battery device, the method comprising the steps of:
providing a housing, a cathode, an anode, an electrolyte, a membrane, a solar panel; and
a plurality of energy connection ports, wherein said plurality of energy connection ports having a set of input ports and a set of output ports, wherein said set of output ports provide electric power source to a set of external devices;
forming a sealed enclosure around said housing including around said cathode, said anode, and said membrane; and
coupling said solar panel to said set of input ports for receiving electric power generated by said solar panel, wherein said solar panel selectively detachable from said set of input ports, wherein said set of input ports function as another set of output ports when said solar panel is detached from said housing.
